(19) United States
(12) Patent Application Publication
(10) Pub. No.: US 2026/0325372 A1
(43) Pub. Date: Oct. 22, 2026

(54) WHEELCHAIR SYSTEM

(71) Applicant: Redhawk Mobility, LLC, Woodstock, GA (US)

(72) Inventor: Brandon Skolnick, Woodstock, GA (US)

(73) Assignee: Redhawk Mobility, LLC, Woodstock, GA (US)

(21) Appl. No.: 19/183,176

(22) Filed: Apr. 18, 2025

(51) Int. Cl. A61G 5/14

(52) U.S. Cl. CPC A61G 5/14; A61G 2203/14

(57) ABSTRACT

A wheelchair system including an arm, a joystick controller and a bracket is disclosed. The arm may have an arm front portion, an arm side portion and an arm bottom portion. The joystick controller may include a joystick to operate wheelchair operations. The bracket may connect the joystick controller with the arm. The bracket may enable the joystick controller to swing relative to the arm, and move between a first position and a second position. The joystick controller may be located in front of the arm front portion in the first position, and adjacent to the arm side portion in the second position.

### TECHNICAL FIELD

The present disclosure relates to a wheelchair system, and more particularly to a wheelchair system having a joystick controller.

### BACKGROUND

A joystick controller in a powered wheelchair is typically used by a user to maneuver the wheelchair while sitting on the wheelchair. The joystick controller provides ability to the user to drive the wheelchair forward, backward, and turn. The joystick controller is a primary method of steering and controlling speed for the wheelchair.

Typically, the joystick controller is positioned at a front edge of a wheelchair arm to allow the user to easily operate the wheelchair. While the conventional positioning of the joystick controller allows the user to easily access the joystick controller and operate the wheelchair, there may be scenarios where such an arrangement of the joystick controller relative to the wheelchair arm may cause inconvenience to the user. For example, when the user desires to move from a sitting position on the wheelchair seat to a standing position (or stand up from the wheelchair), the user may not be able to take the support of the wheelchair arm's front edge as the joystick controller may be obstructing access to the front edge.

Thus, there is a need for a wheelchair system that facilitates a user to comfortably use the wheelchair and enhances user experience of operating the wheelchair.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an exemplary wheelchair system in accordance with the present disclosure.

FIG. 2 depicts an exemplary bracket in accordance with the present disclosure.

FIG. 3 depicts an exploded view of a wheelchair system in accordance with the present disclosure.

FIG. 4 depicts an exemplary first position and a second position of a joystick controller relative to a wheelchair arm in accordance with the present disclosure.

FIG. 5 depicts a wheelchair seat in a lifted position in accordance with the present disclosure.

FIG. 6 depicts a view of a wheelchair system having control buttons on a first wheelchair arm and a second wheelchair arm in accordance with the present disclosure.

### DETAILED DESCRIPTION

### Overview

The present disclosure is directed to a wheelchair system (“wheelchair”) that facilitates a user to comfortably use the wheelchair, and enhances user experience of operating the wheelchair. The wheelchair may include a plurality of components including, but not limited to, a first arm, a second arm, a joystick controller, a wheelchair seat, and/or the like. The joystick controller may facilitate the user to maneuver the wheelchair while sitting on the wheelchair. The joystick controller provides ability to the user to drive the wheelchair forward, backward, and turn. The joystick controller may include a joystick and one or more buttons (or “first buttons”) to perform various wheelchair operations, e.g., move the wheelchair, tilt the wheelchair seat, and/or the like.

The joystick controller may be removably attached to the first arm, and may pivotally rotate relative to the first arm. In some aspects, the joystick controller may swing relative to the first arm and move between a first position and a second position. In the first position, the joystick controller may be located in front of an arm front portion. Further, in the first position, the first arm and the joystick controller may be in a straight line (with the first arm and joystick controller's longitudinal axes coinciding/overlapping with each other), and the joystick controller may be placed just forward of the arm front portion. In the second position, the joystick controller may be located adjacent to an arm side portion. Stated another way, in the second position, the joystick controller may be located along the arm side portion (with the first arm and joystick controller's longitudinal axes parallel to each other but not overlapping), which may enable the user to use the arm front portion for support while standing up from the wheelchair seat (to move from the sitting position to the standing position, and vice versa).

As described above, tn the second position, a joystick controller longitudinal axis may be positioned parallel to a first arm longitudinal axis. When the joystick controller is moved between the first position and the second position, the distance between the ground surface and the joystick controller may remain the same. Thus, the joystick controller may not move vertically relative to the ground, but may rotate horizontally relative to the first arm. The user may position the joystick controller in the first position when the user desires to maneuver the wheelchair or use the joystick controller to control various wheelchair operations. Further, the user may swing the joystick controller to the second position when the user desires to move from the sitting position on the wheelchair seat to the standing position on the ground, or vice versa.

In some aspects, the joystick controller may be removably attached to the first arm via a bracket. The bracket may include a plurality of components including, but not limited to, a first bracket plate, a second bracket plate, a first bar and a second bar. The first bracket plate may engage with the joystick controller, and the second bracket plate may engage with the first arm. Specifically, the first bracket plate may engage or attach with a joystick controller bottom portion, and the second bracket plate may engage or attach with a first arm bottom portion. The first bar and the second bar may be positioned between the first bracket plate and the second bracket plate. The first bar may be attached to the first bracket plate (and/or the joystick controller) via a first connector, and the first bar may be attached to the second bracket plate (and/or the first arm) via a second connector. The second bar may be attached to the first bracket plate (and/or the joystick controller) via a third connector, and the second bar may be attached to the second bracket plate (and/or the first arm) via a fourth connector. The first connector, the second connector, the third connector, and the fourth connector may be fasteners. The first and second bars may enable pivotal rotation of the joystick controller relative to the first arm or their movement between the first position and the second position, via the first, second, third and fourth connectors.

In some aspects, the wheelchair may further include a lifting mechanism that may lift or tilt the wheelchair seat to assist the user in standing up from the wheelchair seat. The lifting mechanism may tilt or pivotally rotate a wheelchair seat back portion relative to the ground to provide support to the user to easily move from the sitting position to the standing position. In some aspects, the lifting mechanism may include a hydraulic device. For instance, the lifting mechanism may include a hydraulic rod that may tilt the wheelchair seat back portion based on command signals obtained from the joystick controller, when the user desires to stand up from the wheelchair seat.

In further aspects, the first arm and the second arm may include control buttons to perform various wheelchair operations. For example, the first arm may include one or more second buttons to make sitting adjustments, lift the wheelchair seat, or perform other wheelchair operations. Similarly, the second arm may include one or more third buttons to make sitting adjustments, lift the wheelchair seat, or perform other wheelchair operations. In some aspects, the second and third buttons may perform all or a subset of operations that the joystick controller can perform.

The second buttons may be positioned in proximity to the arm front portion and on an arm underside surface (or bottom portion) associated with the first arm. Similarly, the third buttons may be positioned in proximity to the arm front portion and on an arm underside surface (or bottom portion) associated with the second arm. The second and third buttons may be positioned such that the user may easily access the second buttons on the first arm and the third buttons on the second arm, using the user's fingertips when the user may be sitting on the wheelchair.

The present disclosure discloses a wheelchair system that includes various features that enhance user experience of operating the wheelchair system. The wheelchair may include pivotably connected joystick controller that may allow the user to take support of the first arm and/or the second arm while moving from the sitting position to the standing position (or vice versa). The wheelchair may further include a lifting mechanism that tilts the wheelchair seat, which facilitates the user to comfortably move from the sitting position to the standing position. In addition, the positioning of the first buttons, the second buttons and the third buttons provide flexibility and convenience to the user to perform various wheelchair operations.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

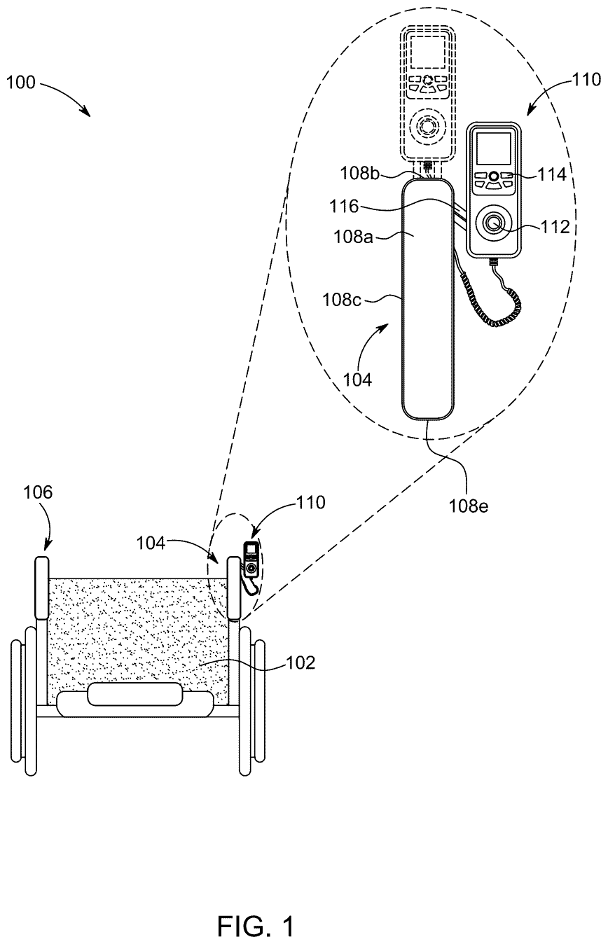

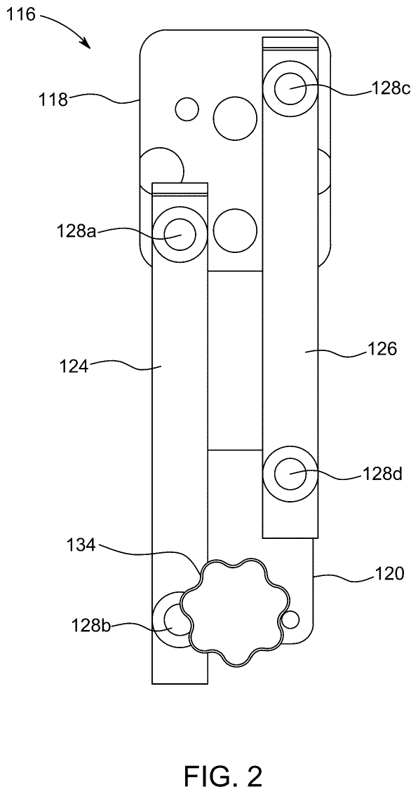

FIG. 1 depicts an exemplary wheelchair system 100 (or wheelchair 100) in accordance with the present disclosure. FIG. 1 will be described in conjunction with FIGS. 2, 3, 4, 5, and 6.

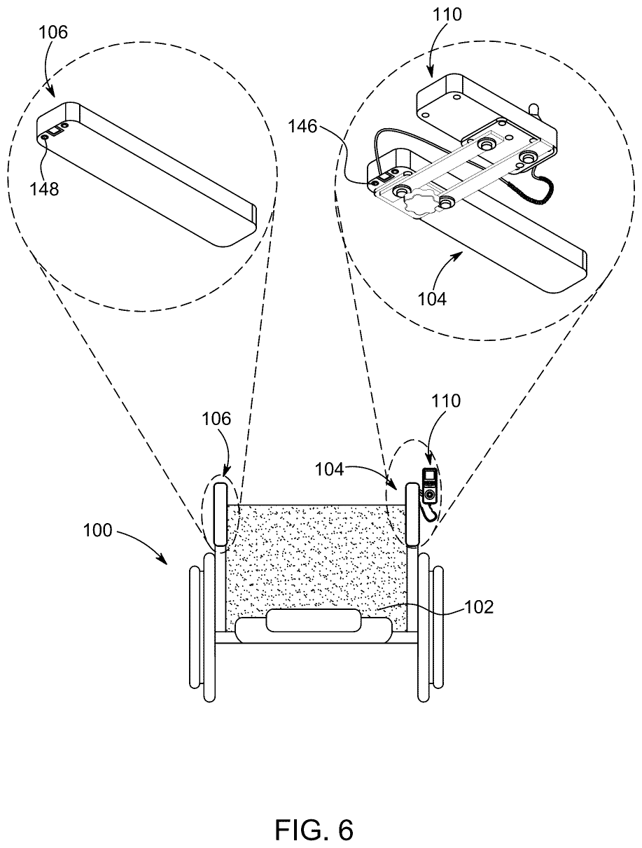

The wheelchair 100 may include a plurality of components including, but not limited to, a plurality of wheels, a wheelchair seat 102 (on which a user may sit), a first arm 104, and a second arm 106. The first arm 104 and the second arm 106 may provide support to the user's arms when the user sits on the wheelchair seat 102. Each of the first arm 104 and the second arm 106 may include an arm top portion 108a, an arm front portion 108b, an arm side portion 108c, an arm bottom portion 108d (shown in FIG. 6), and an arm back portion 108e. The arm bottom portion 108d may face the ground, the arm top portion 108a may be located opposite to the arm bottom portion 108d. The arm front portion 108b may include a hand hold feature that may enable the user to take the support of the first arm 104 and/or the second arm 106 while standing up from the wheelchair seat 102 or moving from a sitting position on the wheelchair seat 102 to a standing position on the ground, or vice versa. In some aspects, the hand hold feature may include an arm rounded end or edge. The arm back portion 108e may be located opposite to the arm front portion 108b. In further aspects, the first arm 104 and the second arm 106 may be configured to move backward and forward to accommodate different sizes of user's arms. In some aspects, the first arm 104 and the second arm 106 may have telescopic mechanism to increase or decrease the arm lengths.

The wheelchair 100 may further include a joystick controller 110 that may be removably attached to the first arm 104. The joystick controller 110 may facilitate the user to maneuver the wheelchair 100 while sitting on the wheelchair 100 and/or control various wheelchair operations. The joystick controller 110 may provide ability to the user to drive the wheelchair 100 forward, backward, and turn. The joystick controller 110 may include a joystick 112 and one or more first buttons 114 to perform various wheelchair operations. The user may use the joystick 112 to drive the wheelchair 100 forward, backward, and turn, and the first buttons 114 to make sitting adjustments, lift the wheelchair seat 102, or perform other wheelchair operations.

The wheelchair 100 may further include a bracket 116 that may removably attach the joystick controller 110 to the first arm 104. In some aspects, the bracket 116 may attach the joystick controller 110 to the arm front portion 108b. The bracket 116 may enable the joystick controller 110 to pivotally rotate relative to the first arm 104. Specifically, the bracket 116 may enable the joystick controller 110 to swing relative to the first arm 104, and move between a first position and a second position. In the first position, the joystick controller 110 may be located in front of the arm front portion 108b. Stated another way, in the first position, the joystick controller 110 may be aligned with the arm front portion 108b (or arm first edge) or a joystick controller longitudinal axis may be coincident with or overlap with a first arm longitudinal axis, as shown in FIG. 1. The user may comfortably access the joystick controller 110 and operate the wheelchair 100 when the joystick controller 110 may be in the first position. Further, in the first position, the first arm 104 and the joystick controller 110 may be in a straight line, and the joystick controller 110 may be placed just forward of the arm front portion 108b.

In the second position, the joystick controller 110 may be located adjacent to the arm side portion 108c. Stated another way, in the second position, the joystick controller 110 may be located along the arm side portion 108c or the joystick controller longitudinal axis may be parallel to the first arm longitudinal axis but may not overlap with it, as shown in FIG. 1. The user may use the arm front portion 108b (or the hand-hold feature located in the arm front portion 108b) as a support to move from the sitting position to the standing position (or vice versa), when the joystick controller 110 may be in the second position.

As described above, in the second position, the joystick controller longitudinal axis may be positioned parallel to the first arm longitudinal axis. When the joystick controller 110 is moved between the first position and the second position, the distance between the ground surface and the joystick controller 110 may remain the same. Thus, the joystick controller 110 may not move vertically relative to the ground, but may only rotate horizontally relative to the first arm 104.

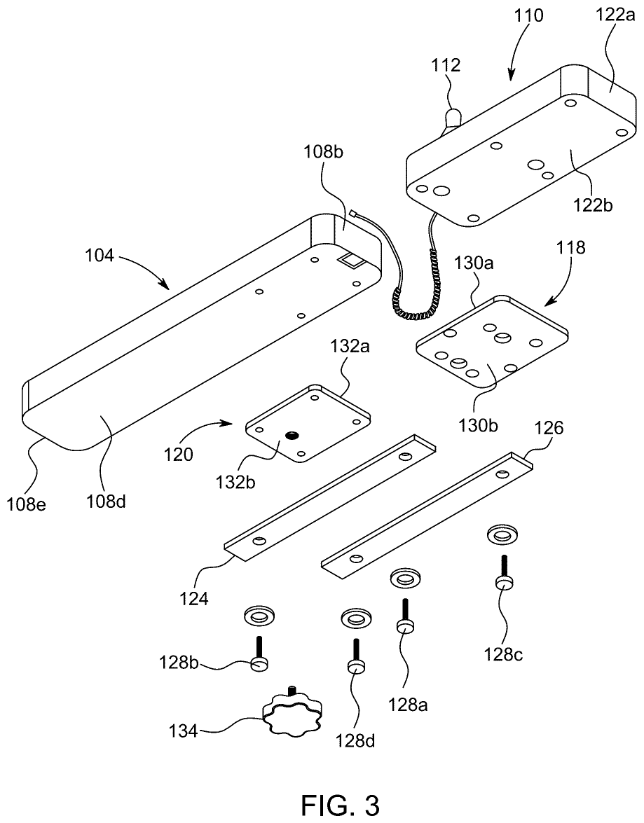

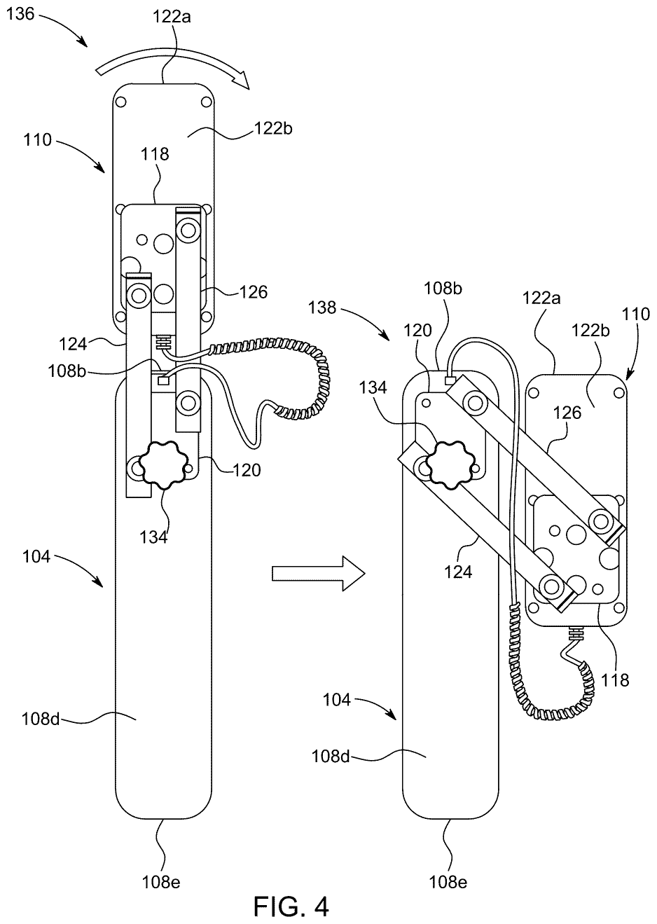

The user may position the joystick controller 110 in the first position when the user desires to maneuver the wheelchair 100, and may swing the joystick controller 110 to the second position (via the bracket 116) when the user desires to move from the sitting position to the standing position, or vice versa. In further aspects, in the first position, a joystick controller front portion 122a (as shown in FIGS. 3 and 4) may face away from the first arm 104 (and/or the user when the user may be sitting on the wheelchair seat 102). In the second position, the joystick controller front portion 122a may face away from the first arm 104 (and/or the user when the user may be sitting on the wheelchair seat 102). Thus, the joystick controller front portion 122a may not rotate (or the orientation of the joystick controller 110 relative to the user may not change) when the user moves the joystick controller 110 from the first position to the second position (or vice versa), which may enable the user to conveniently operate the wheelchair 100 via the joystick controller 110 in both the first and second locations of the joystick controller 110. Stated another way, the joystick controller 110 may not move around its own axis when the joystick controller 110 is moved between the first position and the second position, which enables the user to use the joystick controller 110 in any of its positions.

In some aspects, the bracket 116 may include a first bracket plate 118 and a second bracket plate 120. The first bracket plate 118 may engage with the joystick controller 110 and the second bracket plate 120 may engage with the first arm 104. Specifically, the first bracket plate 118 may engage with a joystick controller bottom portion 122b (that may face the ground, as shown in FIGS. 3 and 4), and the second bracket plate 120 may engage with the arm bottom portion 108d. In some aspects, an entire body of the first bracket plate 118 may be positioned below the joystick controller bottom portion 122b when the first bracket plate 118 is engaged with the joystick controller 110. Similarly, an entire body of the second bracket plate 120 may be positioned below the arm bottom portion 108d when the second bracket plate 120 may be engaged with the first arm 104.

In an exemplary aspect, the first bracket plate 118 and the second bracket plate 120 may be rectangular plates. In some aspects, a first bracket length may be less than a joystick controller length. For instance, the first bracket length may be 30-70% of the joystick controller length. In other aspects, the first bracket length may be equivalent to the joystick controller length. In further aspects, a first bracket width may be less than a joystick controller width. For instance, the first bracket width may be 40-90% of the joystick controller width. In other aspects, the first bracket width may be equivalent to the joystick controller width. In some aspects, first bracket plate dimensions may be equivalent to second bracket plate dimensions. In other aspects, the first bracket plate dimensions may be different from the second bracket plate dimensions.

The bracket 116 may further include a first bar 124 and a second bar 126 (as shown in FIG. 2), which may be positioned between the first bracket plate 118 and the second bracket plate 120. The first bar 124 and the second bar 126 may be identical elongated bars or plates. In some aspects, lengths of the first bar 124 and the second bar 126 may be equivalent and greater than the lengths of the first bracket plate 118 and the second bracket plate 120. In further aspects, widths of the first bar 124 and the second bar 126 may be equivalent and less than the widths of the first bracket plate 118 and the second bracket plate 120.

The first bar 124 and the second bar 126 may be positioned parallel to each other when the first bar 124 and the second bar 126 may be engaged with the first bracket plate 118 and the second bracket plate 120. The first bar 124 and the second bar 126 may enable the joystick controller 110 to swing/move between the first position and the second position. Stated another way, the first bar 124 and the second bar 126 may enable the joystick controller 110 to pivotally rotate relative to the first arm 104.

A first bar 124 top end may be removably attached to a first bracket plate 118 bottom end via a first connector 128a, as shown in FIG. 2. Further, a first bar 124 bottom end may be removably attached to a second bracket plate 120 bottom end, via a second connector 128b. Stated another way, the first bar 124 may be attached at the similar edges (i.e., the bottom edges) of the first bracket plate 118and the second bracket plate 120.

In a similar manner, a second bar 126 top end may be removably attached to a first bracket plate 118 top end, via a third connector 128c. Further, a second bar 126 bottom end may be removably attached to a second bracket plate 120 top end, via a fourth connector 128d. Stated another way, the second bar 126 may be attached at the similar edges (i.e., the top edges) of the first bracket plate 118 and the second bracket plate 120.

In this manner, the first bracket plate 118 may be attached to the first bar 124 and the second bar 126 via the first connector 128a and the third connector 128c. The first connector 128a and the third connector 128c may be disposed on opposite edges (e.g., top and bottom edges) of the first bracket plate 118. In some aspects, the first connector 128a may be disposed at a first corner (e.g., a bottom left corner) and the third connector 128c may be disposed at a second corner (e.g., a top right corner) that may be diagonally located relative to the first corner. Similarly, the second bracket plate 120 may be attached to the first bar 124 and the second bar 126 via the second connector 128b and the fourth connector 128d. The second connector 128b and the fourth connector 128d may be disposed on opposite edges (e.g., top and bottom edges) of the second bracket plate 120. In some aspects, the second connector 128b may be disposed at a first corner (e.g., a bottom left corner) and the fourth connector 128d may be disposed at a second corner (e.g., a top right corner) that may be diagonally located relative to the first corner. Such an arrangement may enable the joystick controller 110 to efficiently swing between the first position and the second position, via the first bar 124, the second bar 126, the first connector 128a, the second connector 128b, the third connector 128c, and the fourth connector 128d. In some aspects, the first connector 128a, the second connector 128b, the third connector 128c, and the fourth connector 128d may be fasteners such as screws that may removably attach the bracket 116 to the joystick controller 110 and the first arm 104.

In some aspects, the first bracket plate 118 may include a first upper surface 130a and a first lower surface 130b, and the second bracket plate 120 may include a second upper surface 132a and a second lower surface 132b, as shown in FIG. 3. The first upper surface 130a may face the joystick controller bottom portion 122b when the first bracket plate 118 may be engaged with the joystick controller 110. The second upper surface 132a may face the arm bottom portion 108d when the second bracket plate 120 may be engaged with the first arm 104. The first lower surface 130b may be attached to the first bar 124 and the second bar 126 via the first connector 128a and the third connector 128c respectively, and the second lower surface 132b may be attached to the first bar 124 and the second bar 126 via the second connector 128b and the fourth connector 128d respectively.

In some aspects, the second bracket plate 120 may be removably attached to the arm bottom portion 108d via a rotating knob screw 134, as shown in FIGS. 3, 4, and 5. The rotating knob screw 134 may enable the user to attach or detach the second bracket plate 120 to or from the first arm 104 without the use of any external tool. The user may rotate the rotating knob screw 134 in a first direction (e.g., a clockwise direction) to attach the second bracket plate 120 to the first arm 104. Further, the user may rotate the rotating knob screw 134 in a second direction (e.g., a counterclockwise direction) to detach the second bracket plate 120 from the first arm 104. In further aspects, the first bracket plate 118 may be removably attached to the joystick controller bottom portion 122 via another rotating knob screw (not shown), in the similar manner as the second bracket plate 120 is attached to the first arm 104 via the rotating knob screw 134.

In operation, the user may position the joystick controller 110 in the first position when the user desires to maneuver the wheelchair 100, and the user may swing the joystick controller 110 to the second position (via the bracket 116) when the user desires to move from the sitting position to the standing position, or vice versa, as shown in FIG. 4. In the first position, longitudinal axes of the first bar 124 and the second bar 126 may be parallel to longitudinal axes of the first arm 104 and the joystick controller 110, as shown in a view 136. In the second position, the longitudinal axes of the first bar 124 and the second bar 126 may not be parallel to the longitudinal axes of the first arm 104 and the joystick controller 110, as shown in a view 138. In the second position, the longitudinal axes of the first bar 124 and the second bar 126 may be disposed at a non-zero angle relative to the longitudinal axes of the first arm 104 and the joystick controller 110. The angle may be greater than zero degrees and may be anywhere between 10-150 degrees, as shown in the view 138.

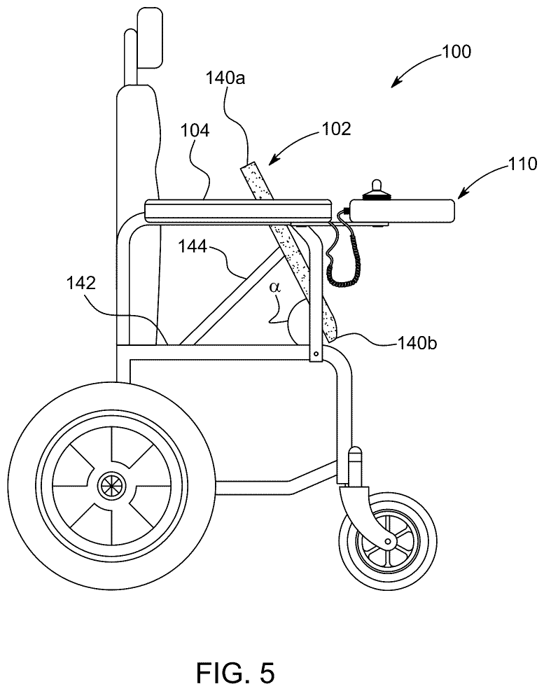

The wheelchair 100 may include additional features that may assist the user to operate the wheelchair 100 comfortably. For example, in some aspects, the wheelchair 100 may include a lifting mechanism that may lift or tilt the wheelchair seat 102 relative to the ground to assist the user in standing from the wheelchair seat 102. The lifting mechanism may tilt or pivotally rotate a wheelchair seat back portion 140a (that may be located in proximity to a wheelchair handrail, as shown in FIG. 5) to provide support to the user to easily move from the sitting position to the standing position. In some aspects, a wheelchair seat front portion 140b (located opposite to the wheelchair seat back portion 140a) may be connected to a wheelchair seat base 142 via a hinge (not shown), which may enable pivotal rotation or tilting of the wheelchair seat 102 (e.g., the wheelchair seat back portion 140a) relative to the ground.

The lifting mechanism may enable the wheelchair seat 102 to move between a normal position and a lifted position (as shown in FIG. 5). In the normal position, the wheelchair seat 102 may be positioned on the wheelchair seat base 142 (on which the wheelchair seat 102 may be positioned) such a wheelchair seat plane may be parallel to a wheelchair seat base plane. In the lifted position, the wheelchair seat 102 may be lifted from the wheelchair seat back portion 140a such the wheelchair seat plane may be disposed at a non-zero angle relative to the wheelchair seat base plane. In some aspects, an angle “α” between the wheelchair seat 102 (or a wheelchair seat front portion 140b) and the wheelchair seat base 142 may be between 20-80 degrees. In some aspects, the lifting mechanism may include a hydraulic device. For instance, the lifting mechanism may include a hydraulic rod 144 that may tilt or loft the wheelchair seat back portion 140a. The lifting mechanism may further include a hydraulic actuator that may actuate the seat lifting movement.

In further aspects, the first arm 104 and the second arm 106 may include one or more control buttons to perform various wheelchair operations. For example, the first arm 104 may include one or more second buttons 146 (as shown in FIG. 6) to make sitting adjustments, lift the wheelchair seat 102, or perform other wheelchair operations. Similarly, the second arm 106 may include one or more third buttons 148 to make sitting adjustments, lift the wheelchair seat 102, or perform other wheelchair operations.

In some aspects, the second buttons 146 may be positioned on the arm bottom portion 108d associated with the first arm 104, and the third buttons 148 may be positioned on the arm bottom portion 108d associated with the second arm 106. Specifically, the second buttons 146 may be positioned in proximity to the arm front portion 108b and on the arm bottom portion 108d associated with the first arm 104. Similarly, the third buttons 148 may be positioned in proximity to the arm front portion 108b and on the arm bottom portion 108d associated with the second arm 106. The second buttons 146 and the third buttons 148 may be positioned such that the user may easily access the second buttons 146 on the first arm 104 and the third buttons 148 on the second arm 106, by using the user's fingertips when the user may be sitting on the wheelchair 100. The user may use the first buttons 114 on the joystick controller 110, the second buttons 146 on the first arm 104, or the third buttons 148 on the second arm 106 to perform any wheelchair operation described above. Such placements of the first buttons 114, the second buttons 146 and the third buttons 148 provide flexibility and convenience to the user to perform various wheelchair operations.

For example, based on the user's disability, the user may use the first buttons 114, the second buttons 146 or the third buttons 148 (whichever is conveniently accessible to the user) to adjust the wheelchair's sitting arrangement or perform any other wheelchair operation. In an exemplary aspect, the user may use the first buttons 114, the second buttons 146 or the third buttons 148 to lift the wheelchair seat 102 as shown in FIG. 5. In additional aspects, the user may use the first buttons 114, the second buttons 146 or the third buttons 148 to move the joystick controller 110 between the first position and the second position. Alternatively, the user may manually rotate the joystick controller 110 between the first position and the second position.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A wheelchair system comprising:
a first arm having a first arm front portion, a first arm side portion, and a first arm bottom portion;
a joystick controller comprising a joystick to operate wheelchair operations; and
a bracket configured to connect the joystick controller with the first arm, wherein:
the bracket enables the joystick controller to swing relative to the first arm, and move between a first position and a second position,
the joystick controller is located in front of the first arm front portion in the first position, and
the joystick controller is located adjacent to the first arm side portion in the second position.

2. The wheelchair system of claim 1, wherein:
the bracket comprises a first bracket plate and a second bracket plate,
the first bracket plate is configured to engage with a joystick controller bottom portion, and
the second bracket plate is configured to engage with the first arm bottom portion.

3. The wheelchair system of claim 2, wherein the bracket further comprises a first bar and a second bar connected between the first bracket plate and the second bracket plate.

4. The wheelchair system of claim 3, wherein the first bracket plate comprises a first upper surface and a first lower surface, and wherein the second bracket plate comprises a second upper surface and a second lower surface.

5. The wheelchair system of claim 4, wherein:
the first upper surface faces the joystick controller bottom portion when the first bracket plate is engaged with the joystick controller, and
the second upper surface faces the first arm bottom portion when the second bracket plate is engaged with the first arm.

6. The wheelchair system of claim 5, wherein:
an entire body of the first bracket plate is positioned below the joystick controller bottom portion when the first bracket plate is engaged with the joystick controller, and
an entire body of the second bracket plate is positioned below the first arm bottom portion when the second bracket plate is engaged with the first arm.

7. The wheelchair system of claim 4, wherein:
the first lower surface is attached to the first bar and the second bar via a first connector and a third connector respectively, and
the second lower surface is attached to the first bar and the second bar via a second and a fourth connector respectively.

8. The wheelchair system of claim 7, wherein:
the first bar is attached to a first bottom end of the first bracket plate, via the first connector,
the first bar is attached to a second bottom end of the second bracket plate, via the second connector,
the second bar is attached to a first top end of the first bracket plate, via the third connector, and
the second bar is attached to a second top end of the second bracket plate, via the fourth connector.

9. The wheelchair system of claim 8, wherein the first bar and the second bar enable pivotal rotation of the joystick controller relative to the first arm and between the first position and the second position, via the first connector, the second connector, the third connector and the fourth connector.

10. The wheelchair system of claim 2, wherein the second bracket plate is configured to removably attach to the first arm bottom portion via a rotating knob screw.

11. The wheelchair system of claim 1 further comprising a lifting mechanism configured to tilt a wheelchair seat relative to ground from a wheelchair seat back portion to assist a user in standing from the wheelchair seat.

12. The wheelchair system of claim 11, wherein the lifting mechanism comprises a hydraulic device.

13. The wheelchair system of claim 1, wherein the joystick controller comprises a first control button configured to perform a wheelchair operation.

14. The wheelchair system of claim 13, wherein the first arm bottom portion comprises a second control button configured to perform the wheelchair operation.

15. The wheelchair system of claim 14, wherein the second control button is located in proximity to the first arm front portion.

16. The wheelchair system of claim 14 further comprising a second arm having a second arm bottom portion, wherein the second arm bottom portion comprises a third control button configured to perform the wheelchair operation.

17. The wheelchair system of claim 16, wherein the third control button is located in proximity to a second arm front portion.

18. A wheelchair system comprising:
an arm having an arm front portion, an arm side portion, and an arm bottom portion;
a joystick controller comprising a joystick to operate wheelchair operations; and
a bracket configured to connect the joystick controller with the arm, wherein:
the bracket enables the joystick controller to swing relative to the arm, and move between a first position and a second position,
the joystick controller is located in front of the arm front portion in the first position,
the joystick controller is located adjacent to the arm side portion in the second position,
the bracket comprises a first bracket plate and a second bracket plate,
the first bracket plate is configured to engage with a joystick controller bottom portion,
the second bracket plate is configured to engage with the arm bottom portion,
an entire body of the first bracket plate is positioned below the joystick controller bottom portion when the first bracket plate is engaged with the joystick controller, and
an entire body of the second bracket plate is positioned below the arm bottom portion when the second bracket plate is engaged with the arm.

19. The wheelchair system of claim 18, wherein the bracket further comprises a first bar and a second bar connected between the first bracket plate and the second bracket plate.

20. A wheelchair system comprising:
a wheelchair seat;
an arm having an arm front portion, an arm side portion, and an arm bottom portion;
a joystick controller comprising a joystick to operate wheelchair operations;
a bracket configured to connect the joystick controller with the arm, wherein:
the bracket enables the joystick controller to swing relative to the arm, and move between a first position and a second position,
the joystick controller is located in front of the arm front portion in the first position, and
the joystick controller is located adjacent to the arm side portion in the second position; and
a lifting mechanism configured to tilt the wheelchair seat relative to ground from a wheelchair seat back portion to assist a user in standing from the wheelchair seat.
